(19) United States
(12) Patent Application Publication
(10) Pub. No.: US 2016/0166904 A1
(43) Pub. Date: Jun. 16, 2016

(54) Soccer Training Device

(71) Applicant: Ian Dunn Bush, Boynton Beach, FL (US)

(72) Inventor: Ian Dunn Bush, Boynton Beach, FL (US)

(21) Appl. No.: 14/967,193

(22) Filed: Dec. 11, 2015

Related U.S. Application Data
(60) Provisional application No. 62/090,718, filed on Dec. 11, 2014.

(51) Int. Cl. A63B 69/00; G09B 19/00

(52) U.S. Cl. CPC A63B 69/002; G09B 19/0038

(57) ABSTRACT

A training device assists soccer players to deflect a soccer ball by bouncing off a vertical wall. The vertical wall includes an anchor wall acting as a brace that extends at an angle where stakes pass through which allows the device to be anchored to ground. The device is made without moving parts as a stand-alone unit that is made by injection molding as a one-piece homogeneous construction. The device can be sold by itself or as a kit having multiple devices including a set of stakes.

### BACKGROUND OF THE INVENTION

1. Field of the Invention

The present invention relates to soccer training devices to assist soccer players improve their skills by mastering eye coordination of the ball and strengthen body coordination.

2. Background

In a sport where skill is key, one's ability is enhanced if a training device is added to their practice. Mastery of soccer requires both eye and foot coordination. While some devices have been known to deflect a ball using nets, those devices are cumbersome to manufacture and use. Deciphering how to assemble such devices and then doing so is time consuming and therefore an additional drawback for the user.

### SUMMARY OF THE INVENTION

The present invention is a training device that helps improve soccer skills. In particular, the training device comprises a stand-alone unit made from injection molding without requiring any form of assembly among the unit. The training device is self-sustaining unit that can withstand blows from a soccer ball hitting it.

The present invention envisions making the stand-alone unit as a homogeneous piece of high strength material requiring at least two stakes that pass through the unit. The unit integrates at least one strengthening web that is housed within the confines of the unit. Furthermore, the unit utilizes strengthening bosses that extend from the outside surface of an anchor wall to further give the unit more impact resistance.

The present invention further integrates end gussets that link a vertical impact wall and the anchor wall giving the illusion that the unit is one solid piece.

While the present invention can be used by a soccer player using a single unit, multiple units can be combined to create training patterns wherein one person trains in a simulated multi-player environment of varying challenging levels of challenge such as the multi-player environment is represented with various training devices of the instant invention. A training pattern can be comprised of two or more instant devices so when combined simulate a soccer match.

The present invention envisions the ideal dimension to be 4 inches high, 4 inches deep, and about 2 feet in length. The size is ideal for a size 5 soccer ball to be kicked on the ground which upon impact against the vertical wall will cause the ball to return to the kicker in the air. This is accomplished just by the height of the vertical wall alone, which 4 inches is to be the magic spot for a ball to project back in the air.

The instant invention further envisions making the unit straight or with a curved profile representing an annular or arch shape. While the plastic material is a factor in providing strength, it is envisioned that the anchor wall, the webs, the pair of gussets, and bosses, collectively or individually provide the unit with greater strength so that the unit becomes lightweight enough to be carried around.

### BRIEF DESCRIPTION OF THE DRAWINGS

FIG. 1 shows an isometric view of a first embodiment of a training kit in a working environment.

FIG. 2 is a front view of the training device.

FIG. 3 is a top view of the training device.

FIG. 4 is a right side view of the training device.

FIG. 5 is a cross-sectional view of section 5-5 across the training device shown in FIG. 2.

FIG. 6 is a cross-sectional view of section 6-6 across the training device shown in FIG. 8.

FIG. 7 is a left side view of the training device and anchors,

FIG. 8 is a bottom view of the training device.

FIG. 9 is a cross-sectional view of section 9-9 across the training device shown in FIG. 7.

FIG. 10 shows an isometric view of an alternative embodiment of a training kit.

### DETAILED DESCRIPTION OF THE PREFERRED EMBODIMENTS

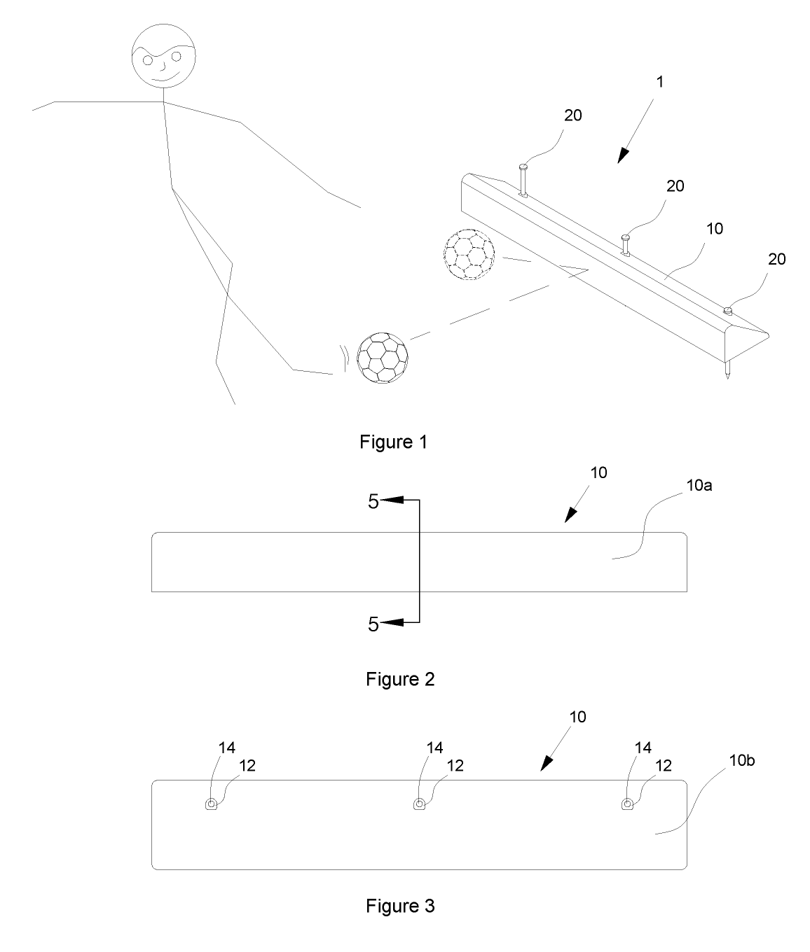

FIG. 1 shows a general environment of a training kit 1 which includes a training device 10 and at least two anchors 20. The training device 10 is best suited to have a 4-inch height so that a soccer player can best reflect a soccer ball off the training device 10 when used. As shown in FIG. 2, the training device 1 includes a front vertical wall 10a that extends the overall length of the training device 10. As shown in FIG. 3, the training device 10 includes an anchor wall 10b that extends at acute angle relative to a top portion of the vertical wall 10a. The anchor wall 10b includes at least two anchor holes 14 that pass through the vertical wall 10a. To strengthen the anchor holes 14, each of the holes 14 pass through a boss 12 that extends from a top surface of the anchor wall 10b parallel to the vertical wall 10a. As shown in FIG. 5, a short back wall 10d extends at an obtuse angle relative to the anchor wall 10b. The back wall 10d further provides structural integrity to the overall training device 10. While not shown, the boss 12 can be made hollow so that the bottom edge of the hole 14 is offset relative to the bottom surface of the anchor wall 10b.

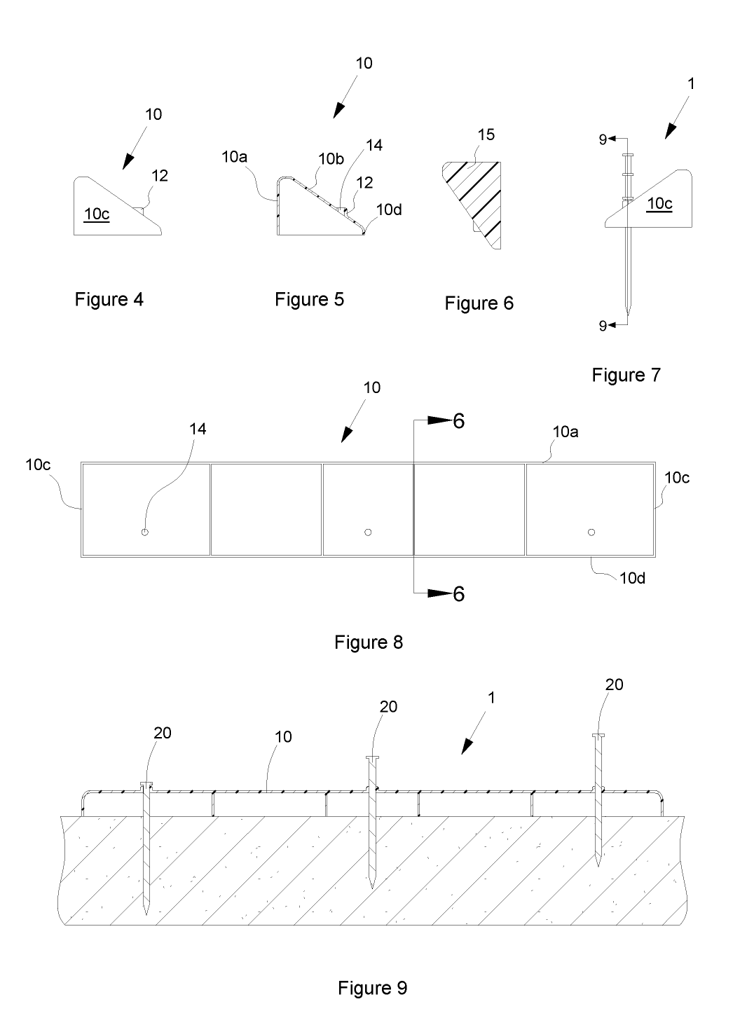

As shown in FIGS. 4, 6, and 8, to further strengthen the training device 10, the front vertical wall 10a, the anchor wall 10b, and the back wall 10d are bridged with webs 15. Further, the end portions of the vertical wall 10a, the anchor wall 10b, and the short wall 10d are covered with a gusset 10c making the training device to be hollow and give the illusion that the training device is a solid piece of material.

The anchor 20 as illustrated in FIGS. 1, 7 and 9 comprises a nail like those with a flanged head and a pointed body. Of course, it envisioned that the anchor 20 can be any form as long as the anchor 20 can penetrate grass turf or plain dirt. For instance, the flanged head maybe replaced with an “L” shape or “J” shape instead so one can pull the anchor 20 out faster.

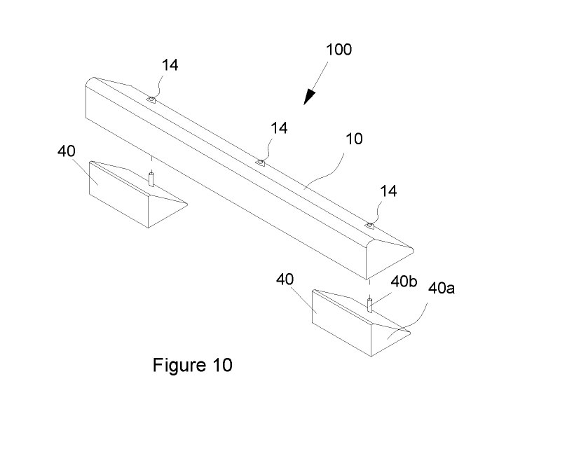

FIG. 10 shows a second embodiment of the training kit 100. Similar as the training kit 10, it includes the same training device 10. In this particular version, the training kit 100 is to be used in an indoor environment as one cannot use anchors 20. FIG. 10 shows the training device 10 in conjunction with anchors 40 in the form of ballasts 40. Two separate ballasts 40 with a dowel 40b sticking up from a weighted body 40a are to be put under the training device 10, and through the holes 14. The dowel 40b is long enough to stick through holes 14 to lock into place or the dowel 40b can be covered with a cap, not shown, on the top of the dowel 40b after they are sticking out through the device. This provides enough weight to keep the device 10 in place for an indoor setting.

Having described details of the training device, it should be envisioned that the training device 10 might be sold as a kit with at least a set of anchors that will fasten the anchor device to ground as shown in FIG. 9. While it is envisioned that the training device 10 is injection molded, any known material can be used to make the training device. It is not just limited to this manufacturing technique. Other methods can be utilized such as casting or machining to make the training device be a homogeneous unit. In addition, the training device can be made in different sizes like having mini-versions for more portability or a longer version for a more permanent team setting.

1. A training device comprising a vertical wall, an anchor wall, and a back wall;
wherein the anchor wall is connected between the vertical wall and the back wall;
wherein the anchor wall extends at an acute angle relative to the vertical wall;
wherein the back wall extends at an obtuse angle relative to the anchor wall; and,
wherein the vertical wall and the back wall are parallel to each other.

2. The training device of claim 1, wherein anchor wall includes at least one boss with an anchor hole.

3. The training device of claim 1, wherein end portions of the back wall, the anchor wall, and the vertical wall being directly covered with a gusset.

4. The training device of claim 1, wherein opposite end portions of the back wall, the anchor wall, and the vertical wall are each covered with a gusset.

5. The training device of claim 2, wherein a series of webs bridge between the back wall, the vertical wall, and the anchor wall to strengthen the vertical wall.

6. The training device of claim 3, wherein a series of webs bridge between the back wall, the vertical wall, and the anchor wall to strengthen the vertical wall.

7. The training device of claim 4, wherein a series of webs bridge between the back wall, the vertical wall, and the anchor wall to strengthen the vertical wall.

8. The training device of claim 2, wherein the anchor hole extends parallel to the vertical wall and the back wall.

9. The training device of claim 2, in combination with at least one anchor passing through the anchor hole.

10. The training device of claim 9, wherein the anchor comprises an elongated nail.

11. The training device of claim 9, wherein the anchor comprises a ballast including a dowel which passes through the anchor hole.

12. A training device comprising a vertical wall, an anchor wall, and a back wall;
wherein the anchor wall is connected between the vertical wall and the back wall;
wherein the anchor wall extends at an acute angle relative to the vertical wall;
wherein the back wall extends at an obtuse angle relative to the anchor wall;
wherein anchor wall includes at least two bosses each with an anchor hole; and,
wherein opposite end portions of the back wall, the anchor wall, and the vertical wall are each covered with a gusset.

13. The training device of claim 12, wherein a series of webs bridge between the back wall, the vertical wall, and the anchor wall to strengthen the vertical wall.

14. The training device of claim 12, wherein the anchor hole extends parallel to the vertical wall and the back wall.

15. The training device of claim 12, in combination with at least two anchors each respectively passing through the anchor hole of the bosses.

16. A training device comprising a vertical wall, an anchor wall, a pair of gussets;
wherein the anchor wall is connected to the vertical wall;
wherein the anchor wall extends at an acute angle relative to the vertical wall;
wherein anchor wall includes at least two bosses each with an anchor hole; and,
wherein opposite end portions of the back wall, the anchor wall, and the vertical wall are covered with the gussets.

17. The training device of claim 16, wherein a series of webs bridge between the back wall, the vertical wall, and the anchor wall to strengthen the vertical wall.

18. The training device of claim 16, in combination with at least two anchors each respectively passing through the anchor hole of the bosses.

19. The training device of claim 16, wherein the anchor comprises an elongated nail.

20. The training device of claim 18, wherein the anchor comprises a ballast including a dowel which passes through the anchor hole.
